(19) United States
(12) Patent Application Publication
(10) Pub. No.: US 2019/0082887 A1
(43) Pub. Date: Mar. 21, 2019

(54) COOKER WITH IGNITION SYSTEM FOR SOLID FUEL

(71) Applicant: Shriro Australia Pty Limited, Kingsgrove (AU)

(72) Inventors: Mark Farrell, Kingsgrove (AU); Alan Roper, Kingsgrove (AU); Chris Taylor, Kingsgrove (AU)

(21) Appl. No.: 16/004,658

(22) Filed: Jun. 11, 2018

(30) Foreign Application Priority Data
Sep. 21, 2017 (AU) 2017232161

(51) Int. Cl. A47J 37/07; F23Q 7/02; F23Q 7/22

(52) U.S. Cl. CPC A47J 37/0763; A47J 37/079; F23Q 7/22; F23Q 7/02

(57) ABSTRACT

The present disclosure relates to a solid-fuel cooker, such as a barbecue, comprising: a body defining a chamber configured to act as a firebox for combustion of solid fuel, such as charcoal or briquettes; a fuel support structure for supporting the solid fuel in the chamber; and an ignition system for igniting the solid fuel supported by the support structure. The ignition system comprises at least one electric heating element mounted to the body and located in or adjacent to the chamber for heating the solid fuel supported by the support structure, the at least one electric heating element configured to be switched between an electrically energized (i.e. switched “on”) state and an electrically de-energized (i.e., switched “off”) state. The at least one electric heating element is configured to transfer heat to the solid fuel supported by the support structure to ignite the solid fuel when the switch is operated to the electrically energized (i.e. switched “on”) state.

### FIELD

The present invention relates to a cooker, and especially to a solid-fuel cooker, such as a barbecue, for outdoor use.

It will be appreciated that the invention has application to a range of different types of cookers that use solid fuels, such as wood chips, charcoal or briquettes. These cookers include, but are not limited to, barbecues, grills, smokers, outdoor ovens, pizza ovens, and the like, and it will be convenient to describe the invention herein in this exemplary context.

### BACKGROUND

Barbecues that are designed to use solid fuel, such as wood, charcoal or briquettes, to cook food have been known for many years. Typically, such barbecues have a chamber called a firebox for accommodating the solid fuel during combustion and a cooking grill disposed above the firebox so that the heat generated by the combustion of the solid fuel in the firebox is transferred to the cooking grill.

Before cooking on such solid-fuel barbecues may commence, it is first necessary for the solid fuel to be ignited. To this end, a user traditionally starts a fire in the firebox from paper and wood. Either the wood slowly reduces to coals for use in cooking, or additional solid fuel in the form of charcoal or briquettes are included in the fire and are then slowly ignited for use in subsequent cooking. This traditional technique has the disadvantage, however, that it is quite complicated and time consuming before the solid fuel is suitably ignited for cooking. In another technique, the solid fuel is placed in the firebox together with a highly flammable liquid or other highly flammable items, such as firelighters, applied on or amongst the solid fuel. By igniting the highly flammable liquid or items with a naked flame from a match or a cigarette lighter, the surrounding solid fuel is gradually ignited to combustion for use in cooking. A disadvantage of this technique, however, is that such highly flammable liquids and items can expose the user to the risk of accidents and/or injury if used improperly. Also, components of the petrochemicals typically contained in such highly flammable liquids or items can be transferred to food during the cooking process.

### SUMMARY OF INVENTION

In view of the above, it is an object of the present invention to provide a cooker, such as a barbecue, that substantially overcomes or at least ameliorates one or more of the disadvantages discussed above.

According to one aspect the present invention provides a cooker, such as a barbecue, comprising: a body defining a chamber configured to act as a firebox for combustion of solid fuel, such as charcoal or briquettes; a fuel support structure for supporting the solid fuel in the chamber; and an ignition system for igniting the solid fuel supported by the support structure. The ignition system comprises: at least one electric heating element mounted to the body and located in or adjacent to the chamber for heating the solid fuel supported by the support structure; and a switch operable between a first state, in which the at least one electric heating element is electrically energized (i.e., switched “on”), and a second state, in which the at least one electric heating element is electrically de-energized (i.e., switched “off”). The at least one electric heating element is configured to transfer heat to the solid fuel supported by the support structure to ignite the solid fuel when the switch is operated to the first state.

According to another aspect, the present invention provides a cooker, such as a barbecue, comprising: a body defining a chamber for combustion of solid fuel, such as wood, charcoal or briquettes; a fuel support structure for supporting solid fuel in the chamber; and an ignition system for igniting solid fuel supported by the fuel support structure, the ignition system comprising at least one electric heating element mounted to the body for heating solid fuel supported by the fuel support structure, the at least one electric heating element configured to be switched between an electrically energized or “on” state and an electrically de-energized or “off” state. The at least one electric heating element is arranged to transfer heat to solid fuel supported by the fuel support structure to ignite the solid fuel when it is switched to the energized or “on” state. The cooker preferably further includes a cooking grill for supporting food items to be cooked spaced above the solid fuel supported on the fuel support structure in the chamber.

In a preferred embodiment, the chamber of the cooker is upwardly open, or has an upper opening (that may optionally include a lid or a cover) for the introduction of the solid fuel onto the fuel support structure. In this way, the body of the cooker may be designed for introducing the solid fuel from above through an upper opening formed in or by the cooker body onto the fuel support structure, as is known in conventional barbecue design. The fuel support structure is preferably configured as a receptacle, such as a basin or tray, for holding the solid fuel. The cooker (e.g., barbecue) typically comprises a cooking grill that is mountable to the body so that the cooking grill is located spaced above the solid fuel supported on the fuel support structure in the chamber, as will be understood in the art.

In a preferred embodiment, the ignition system comprises a controller that is operatively associated with or connected to the at least one electric heating element and/or the switch. The controller is desirably configured to operate the switch and/or the at least one electric heating element from the first (i.e. “on”) state to the second (i.e. “off”) state automatically after a predetermined period of time has elapsed; i.e. following operation to the first (i.e. “on”) state. The predetermined period of time may be in the range of about 2 minutes to about 20 minutes, preferably in the range of about 5 minutes to about 15 minutes, and more preferably in the range of about 5 minutes to about 10 minutes.

In a preferred embodiment, the ignition system further comprises a user interface for operating the controller or the switch. In this regard, the user interface may include a screen, such as a touch-screen, which provides a display for a user. The screen is preferably configured to provide the user with information on any one or more of: the state of the switch or the heating element, a grill temperature, and the time remaining before the predetermined period of time has elapsed; i.e. indicating that adequate combustion of the solid fuel has occurred to commence cooking.

In a preferred embodiment, the at least one electric heating element is arranged in the chamber of the body of the cooker such that, when the solid fuel is placed on the fuel support structure, the at least one electric heating element is substantially surrounded by, and optionally in direct contact with, the solid fuel.

In an alternative preferred embodiment, the fuel support structure is configured to be arranged in the chamber of the body of the cooker such that it is located above, e.g. immediately above, the at least one electric heating element. In this regard, the fuel support structure may include an insert, such as a plate member, in a base thereof for covering and protecting the at least one heating element, but which nevertheless permits or promotes the transfer of heat from the heating element to the solid fuel. To this end, the insert has a lower surface arranged above the at least one heating element and an upper surface arranged for contact with the solid fuel. This insert may include a plurality of apertures extending there-through, i.e. from the lower surface to the upper surface, to promote heat transfer also via radiation and convection. The fuel support structure, or at least the insert portion thereof, may be formed from stainless steel, although other thermally conductive materials, such as other metals or metal alloys, are also contemplated.

In a preferred embodiment, the at least one electric heating element comprises: a pair of electrical connectors configured for electrical connection to an electrical power source, e.g. via the switch; an electrical resistance heating wire arranged to electrically interconnect the pair of electrical connectors; and a sheath of electrically insulating and thermally conductive material surrounding and encapsulating the resistance heating wire. The electrical resistance heating wire is preferably formed from a nickel chromium alloy, and the sheath is preferably formed from magnesium oxide. The at least one electric heating element may further comprise a cover layer covering the sheath, with the cover layer preferably being formed from stainless steel.

In a preferred embodiment, the at least one electric heating element is elongate and may extend in a convoluted configuration, e.g. a serpentine or coiled configuration, to concentrate the transfer of heat to the solid fuel supported on the fuel support structure; for example, via the said insert or plate member of the fuel support structure in thermal contact with the fuel. In the context of this application, thermal contact or heat transfer includes any one or more of heat conduction, heat radiation, and convection.

In a preferred embodiment, the ignition system further comprises an electric cable for connection to an electrical power supply socket to supply electrical energy to the at least one heating element. The electric cable is preferably wound on a spool in the body of the cooker, with the spool being under torsional bias for retracting the cable after ignition of the solid fuel.

According to at least one preferred embodiment, the invention thus provides a cooker, such as a barbecue, comprising: a body defining a chamber for combustion of solid fuel, such as charcoal or briquettes; a fuel support structure for supporting solid fuel in the chamber; a cooking grill for supporting food items to be cooked spaced above the solid fuel supported on the fuel support structure in the chamber; and an ignition system for igniting solid fuel supported by the fuel support structure, the ignition system comprising at least one electric heating element mounted to the body for heating solid fuel supported by the fuel support structure, the at least one electric heating element configured to be switched between an electrically energized or “on” state and an electrically de-energized or “off” state. The at least one electric heating element is arranged to transfer heat to solid fuel supported by the fuel support structure to ignite the solid fuel when it is switched to the energized or “on” state. The at least one electric heating element is elongate and extends in a convoluted or serpentine configuration to concentrate heat transfer to the solid fuel on the fuel support structure. The fuel support structure is configured as a basin or a tray for holding the solid fuel in the chamber above the at least one electric heating element, and the fuel support structure includes an insert, such as a plate member, having a lower surface arranged above the at least one heating element and an upper surface for contact with the solid fuel.

According to at least one preferred embodiment, the invention also provides a cooker, such as a barbecue, comprising: a body defining a chamber to act as a firebox for combustion of solid fuel, such as charcoal or briquettes; a fuel support structure for supporting solid fuel in the chamber; and an ignition system for igniting solid fuel supported by the fuel support structure, the ignition system comprising at least one electric heating element mounted to the body for heating solid fuel supported by the fuel support structure, the at least one electric heating element being switchable to an electrically energized or “on” state and to an electrically de-energized or “off” state and being configured and arranged to transfer heat to solid fuel supported by the fuel support structure to ignite the solid fuel when switched to the electrically energized or “on” state. The ignition system includes a controller that is configured to switch the at least one electric heating element from the “on” state to the “off” state automatically after a predetermined period of time in the range of about 2 minutes to 20 minutes has elapsed. The fuel support structure is configured as a receptacle, such as a basin or a tray, for holding the solid fuel and the chamber is upwardly open for introducing the solid fuel onto the fuel support structure from above, wherein the at least one electric heating element is located in or adjacent the chamber and the fuel support structure is arranged in the chamber above the at least one electric heating element. The fuel support structure includes an insert, such as a plate member, that covers the at least one heating element, the insert having a plurality of apertures there-through.

### BRIEF DESCRIPTION OF DRAWINGS

For a more complete understanding of the invention and the advantages thereof, exemplary embodiments of the invention will be explained in more detail in the following detailed description with reference to the accompanying drawings, in which like reference signs designate like parts, and in which:

FIG. 1 is a perspective view of a cooker according to a preferred embodiment;

FIG. 2 is a top view of the cooker shown in FIG. 1 without the cooking grill;

FIG. 3 is a front view of the cooker shown in FIG. 1 with detail of a user interface;

FIG. 4 is a perspective view of an electric heating element of the cooker of FIG. 1;

FIG. 5 is a schematic cross-sectional view of the heating element of FIG. 4;

FIG. 6 is a perspective view of a cooker according to another preferred embodiment;

FIG. 7 is a top view of the cooker of FIG. 6 without the cooking grill;

FIG. 8 is a front view of the cooker shown in FIG. 6 with detail of a user interface;

FIG. 9 is a front view of a cooker according to a further preferred embodiment; and

FIG. 10 is a top view of the cooker shown in FIG. 9 with detail of a user interface.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will also be understood that certain actions and/or steps in an embodiment of a method may be described or depicted in a particular order of occurrences while those skilled in the art will understand that such specificity with respect to sequence is not actually required.

### DESCRIPTION OF EMBODIMENTS

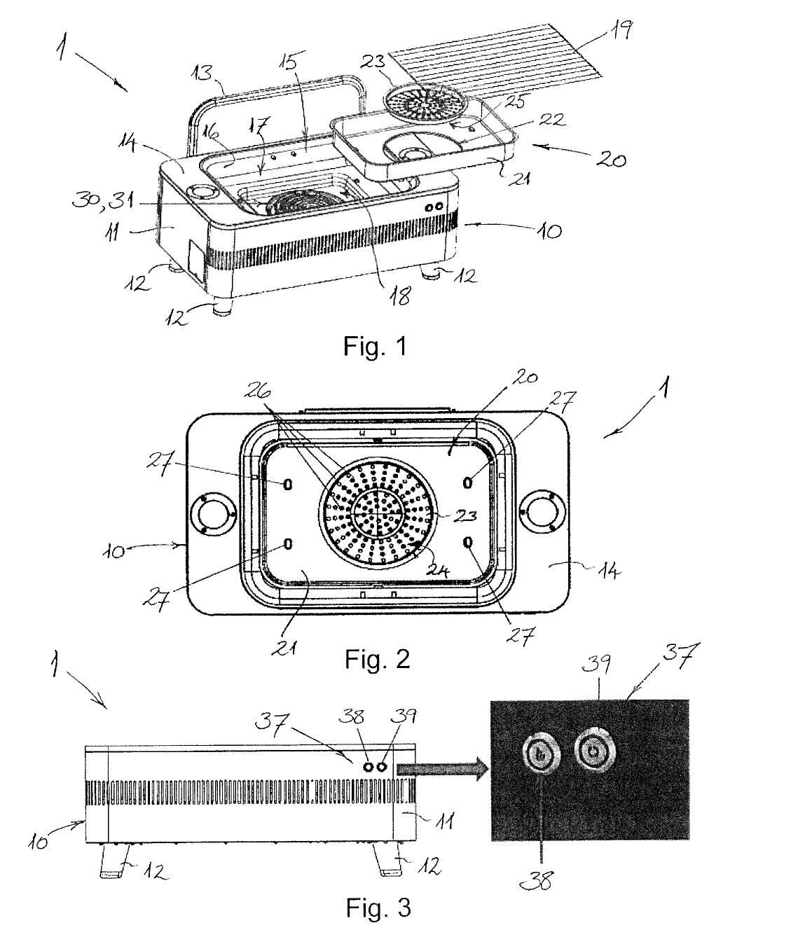

Referring firstly to FIGS. 1 to 3 of the accompanying drawings, a cooker 1 in the form of a barbecue according to a preferred embodiment is illustrated. The barbecue 1 utilises solid fuel, such as charcoal and briquettes (not shown), which undergoes combustion to produce heat for cooking food.

As shown in FIGS. 1 to 3, the barbecue 1 comprises a generally rectangular body 10 having a base portion 11 with footings or legs 12 for supporting the barbecue 1 on a generally flat surface, such as on a bench-top or table. The body 10 of the barbecue 1 includes a lid or cover 13 which is designed to fit over and cover an upper surface 14 of the body 10 when the barbecue is not in use in order to protect parts of the barbecue 1 from the weather in an outdoor environment, and especially to prevent ingress of water. In FIG. 1 the lid or cover 13 is shown in a position where it has been removed from the upper surface 14 of the body 10 and placed resting on an edge thereof behind the body 10. In this regard, the rear side of the body 10 may optionally include a fixture or bracket (not shown) for receiving and holding the lid or cover 13 when it is removed from the upper surface 14 of the barbecue body 10.

The generally rectangular body 10 of the barbecue 1 includes a chamber 15 that is designed to receive the solid fuel, e.g., charcoal or briquettes (not shown), for combustion and thus acts as a firebox for combustion of the solid fuel. To this end, a fuel support structure 20 is provided for supporting the solid fuel in the chamber 15. In this embodiment, the fuel support structure 20 comprises a removable tray or basin 21 to hold and support the charcoal or briquettes. The chamber 15 of the body 10 opens to the upper surface 14 for introducing the tray or basin 21 into the chamber or firebox 15 and for placing the solid fuel onto the support structure 20 from above. The tray or basin 21 is typically shaped and sized to generally match the dimensions of the chamber 15 such that the tray or basin 21 is configured to sit and nest neatly within the chamber 15. In this regard, it will be seen from FIG. 1 that the chamber 15 is essentially defined by inner walls 16, 17 of the body 10. More particularly, inner side walls 16 and an inner base wall 17 define the chamber 15 and a base of the tray or basin 21 seats against the inner base wall 17 when the tray or basin 21 for the solid fuel is received and accommodated in the chamber 15. The fuel support structure 20 is typically formed from sheet metal; it may, for example, be pressed or drawn. As an example, it may be formed from steel, such as stainless steel. It may also be coated, e.g., enamelled, for additional durability and corrosion resistance. Indeed, such materials may be employed for the fabrication of the various component parts of the barbecue 1.

As can be seen in FIGS. 1 and 2, the fuel support structure 20 includes an opening 22 formed in the base of the rectangular basin or tray 21 and an insert 23, which is configured to be received and to seat within that opening 22. The insert 23 is in the form of a plate member and forms a thermally-conductive portion of the fuel support structure 20 for covering a heating element of the barbecue 1 to be described in detail below. In this regard, it will be noted that, although the entire fuel support structure 20 may be thermally conductive, the insert 23 is typically designed to have high thermal conductivity and may be manufactured from any suitable material, such as stainless steel. The plate-like insert 23 is generally flat, disc-shaped and has an upper surface 24, a lower surface 25, and a plurality of holes or apertures 26 that extend through it between the upper and lower surfaces 24, 25. When the solid fuel is placed onto the support structure 20, the insert 23 should be substantially covered by the fuel such that it is in direct physical and thermal contact with upper surface 24 of the plate-like insert 23. The basin or tray 21 of the fuel support structure 20 also includes four dimples or indentations 27 formed or pressed in the base thereof which interact with complementary elements (not shown) in the inner base wall 17 of the chamber 15 for locating and securely positioning fuel support structure 20 in the chamber 15 during use.

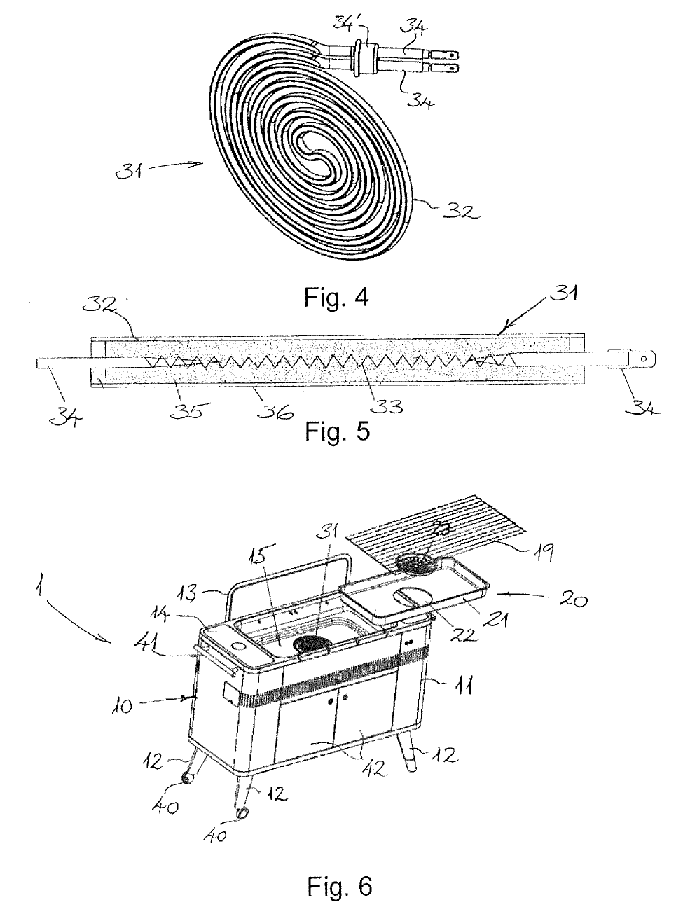

With particular reference to FIG. 1, it will be noted that the barbecue 1 further comprises an ignition system 30 for igniting the solid fuel. In particular, the ignition system 30 includes an electric heating element 31 which is accommodated in a recess 18 which is formed in or defined by the body 10 of the barbecue 1 below the fuel support structure 20. Details of the shape and configuration of the electric heating element 31 are illustrated in FIGS. 4 and 5 of the drawings. In particular, the heating element 31 comprises an elongate body 32 which extends in a coiled configuration to produce a generally flat or planar circular shape. As seen in FIG. 5, the elongate body 32 includes an electrical resistance heating wire 33 (e.g., Cr20Ni80) which extends through its length and interconnects a pair of electrical connectors 34. The heating wire 33 is encased in a sheath 35 of electrically insulating and thermally conductive material (e.g., MgO) and may further comprise a cover layer 36 of stainless steel (e.g., SUS304). The heating element 31 is configured to be powered by usual town main electricity supply of 230 V/120 V. The heating element 31 may be rated at 1800 W/1400 W (+5%-10%) and 1800V/0.5 mA/S for a current of 0.5 mA with a resistance of 10 MΩ. The electrical connectors 34 extending from the elongate body 32 are preferably designed for movement of the heating element 31 after its insertion in an electrical socket (not shown) in the recess 18. In particular, a collar or fixture 34′ on the electrical connectors 34 may be designed to permit the heating element 31 to swivel or pivot (e.g. upwardly out of the recess 18) to facilitate cleaning of the heating element 31 itself and of the barbecue body 10 (i.e. to remove ash and accumulated grime) when not in use.

The electric heating element 31 of the ignition system 30 is therefore mounted in the body 10 of the barbecue 1 and arranged immediately below the fuel support structure 20 in the chamber 15 such that the heating element 31 is directly below and covered by the plate-like insert 23, which protects the heating element 31. The heating element 31 is thus in thermal contact with the lower surface 25 of the plate-like insert 23, and radiant heat can be transferred from the heating element 31 to the solid fuel (e.g. charcoal or briquettes) supported by the fuel support structure 20 via the insert 23 itself and via the holes or apertures 26 in the insert 23. The electric heating element 31 is thus configured and arranged for heating the solid fuel (e.g. charcoal or briquettes) supported by the support structure 20.

The ignition system 30 further includes a controller (not shown) having a user interface 37 and a switch 38 operable for activating and deactivating the electric heating element 31. In particular, the switch 38 in this embodiment comprises a manually operable button incorporated in a front panel of the body 10 of the barbecue 1. In this regard, when it is pressed by a user, the switch or button 38 is operable between a first state, in which the electric heating element 31 is electrically energized (i.e., switched “on”), and a second state, in which the electric heating element 31 is electrically de-energized (i.e., switched “off”). When the button 38 is switched “on” or operated to the first state, the heating element 31 is configured and arranged to transfer heat very quickly to the solid fuel supported on the support structure 20 to ignite the solid fuel. As will be seen in FIG. 3, which illustrates the user interface 37 in more detail, the ignition system 30 optionally includes a further switch 39, again embodied in the form of a button, for otherwise regulating operation of the heating element 31. The controller (which may include e.g., a programmable microcontroller) of the ignition system 30 is operatively connected to the switch 38 and is configured to operate the switch 38 from the first (“on”) state to the second (“off”) state when a predetermined or pre-set period of time has elapsed following the operation of switch 38 to the first (“on”) state. The predetermined period of time is typically in the range of 5 to 10 mins, e.g., about 7 or 8 minutes. In other words, after this relatively short period of time, the heating element 31 of the ignition system 30 will have sufficiently ignited the solid fuel to enable cooking on the barbecue to commence. In addition to the insert 23 of the fuel support structure 20 providing effective heat transfer from the heating element 31 to the solid fuel supported in the basin or tray 21 in order to ignite the fuel, the plate-like insert 23 also acts to shield or protect the heating element 31 from direct contact with the burning charcoal or briquettes following the ignition. This contributes to a longer life of the heating element 31.

With reference again to drawing FIG. 1, it will be seen that the barbecue 1 also includes a cooking grill 19 which is designed to be removably received on the top of the body 10 spaced above the fuel support structure 20 holding the hot charcoal or briquettes (or the like) generating the heat for cooking. In particular, the cooking grill 19 is configured to be seated or mounted lying flat above the firebox or chamber 15 and the food items to be cooked are then placed on the grill 19 in the usual manner.

Although not shown in the drawings, it will be noted that the ignition system 30 further comprises an electric cable for connecting the barbecue 1 to an electrical power supply; e.g., via a conventional plug and socket connection. In this way, electrical power may be supplied to the electric heating element 31 during ignition of the solid fuel. The electric cable (not shown) is wound on a spool (not shown) that is mounted within the body 10 of the barbecue 1, preferably in a thermally insulated compartment or a compartment sufficiently remote from the chamber 15 to avoid heat damage to the cable. The spool is provided with a torsional bias by a spring (not shown) such that the electrical cable may be unwound from the spool by applying a tensile force to extend the cable by a sufficient length to connect with the electrical power supply socket. After the ignition of the solid fuel is complete, the electrical cable can be disconnected from the electrical power supply socket and then retracted and rewound back on to the spool using the torsional bias of the spring.

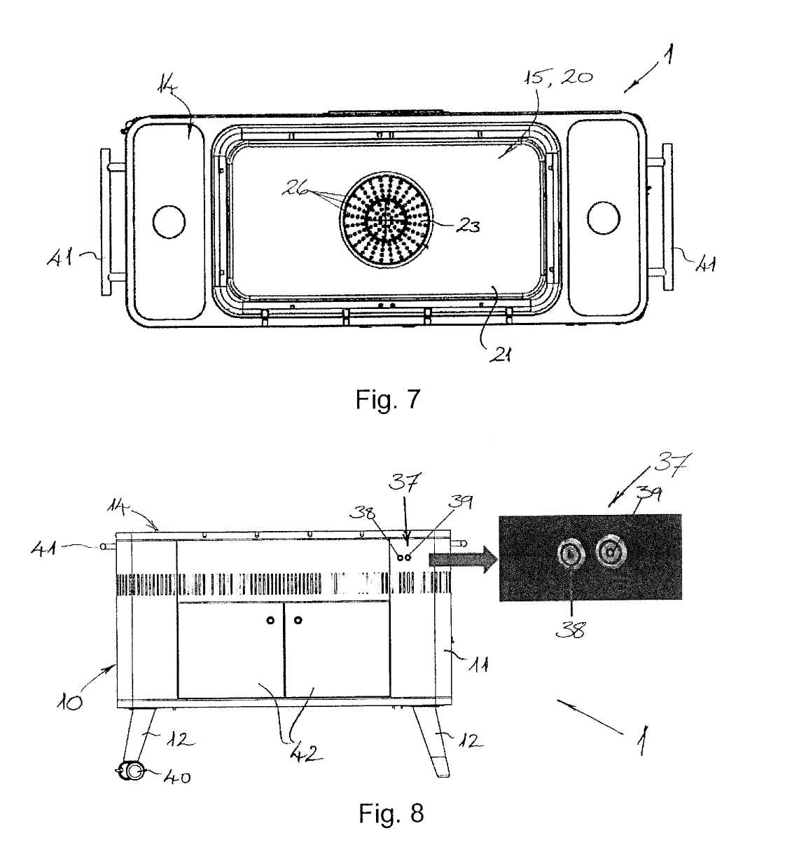

With reference to FIGS. 6 to 8 of the drawings, another embodiment of a barbecue 1 is illustrated. In this case, the body 10 of the barbecue is larger, and the barbecue 1 is configured in a trolley style, such that this version is clearly designed to stand on the ground, and includes wheels 40 on at least some of the legs or footings 12 and handles 41 for moving the barbecue 1 to a desired position. As the body 10 of the barbecue 1 in this embodiment is generally larger, the chamber or firebox 15 is somewhat larger than in the embodiment of FIGS. 1 to 3, as is the fuel support structure 20 which is received in and removable from the chamber 15. It will also be noted that the body 10 includes doors 42 in a front side of the barbecue 1 providing access to a storage compartment within the body 10 below the chamber 15. However, apart from general dimensions, the structure and operation of the parts of the barbecues 1 in this embodiment, such as the ignition system 30, remain substantially unchanged from the embodiment of FIGS. 1 to 3.

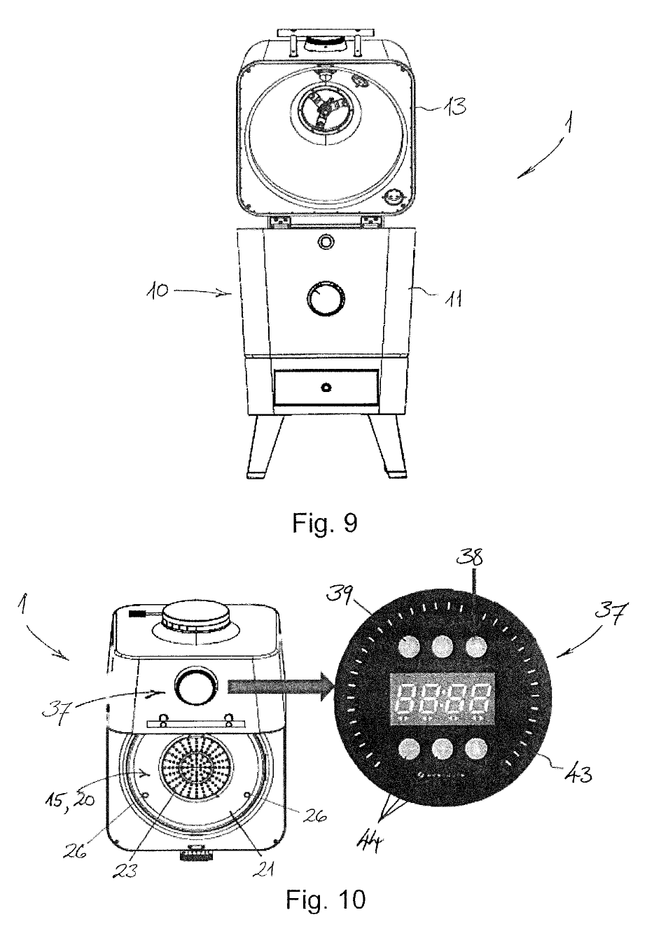

Referring now to FIGS. 9 and 10 of the drawings, a different embodiment of a cooker 1 is illustrated in the form of an outdoor oven or smoker. This oven or smoker 1 shown in FIGS. 9 and 10 has a lid or hood 13 which is hinged to the body 10 and which is designed to cooperate with the body 10 to enclose a cooking space or cavity when it is in the closed position. The oven or smoker 1 of this embodiment is again for solid fuel, such a wood chips, charcoal, briquettes or the like, and to this end incorporates an ignition system 30 as described above in connection with the embodiment of FIGS. 1 to 3. In this embodiment, however, the user interface 37 comprises a screen 43, such as a touch screen, which incorporates a switch 38 for activating and deactivating the heating element 31, as well as an optional additional switch 39 for controlling the oven or smoker 1. The screen 43 is preferably configured to provide a user of the cooker with information on the operational state of the cooker 1, such as one or more of: (i) a current state of the switch 38, (ii) a temperature, e.g., a temperature within the cooking chamber and/or a grill temperature, and (iii) time remaining until the predetermined period of time has elapsed for ignition of the solid fuel. In addition, control buttons or switches 44 may be provided for a user to set or input desired operating parameters of the cooker 1, including the predetermined ignition time for the electric heating element 31. The ignition system 30 in all of the embodiments described herein preferably includes a thermal sensor (not shown) for monitoring the temperature within the chamber or firebox 15. In particular, the thermal sensor (which may take the form of a thermostat) is designed to cut power to the electric heating element 31 if the temperature in the chamber 15 exceeds a pre-set or predetermined threshold temperature. This effectively prevents actuation of the heating element 31 if the firebox or chamber 15 is already full of burning fuel (e.g., charcoal burning at approx. 600° C.) such that additional undesirable heat loading, that could lead to premature deterioration of the heating element 31 or of the electrical elements of the ignition system 30, may be avoided.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

1. A cooker, such as a barbecue, comprising:
a body defining a chamber configured to act as a firebox for combustion of solid fuel, such as charcoal or briquettes;
a fuel support structure for supporting solid fuel in the chamber; and
an ignition system for igniting solid fuel supported by the fuel support structure, the ignition system comprising: at least one electric heating element mounted to the body for heating solid fuel supported by the fuel support structure; and a switch operable between a first state, in which the at least one electric heating element is electrically energized, and a second state, in which the at least one electric heating element is electrically de-energized,
wherein the at least one electric heating element is configured and arranged to transfer heat to solid fuel supported by the fuel support structure to ignite the solid fuel when the switch is operated to the first state.

2. The cooker according to claim 1, wherein the ignition system includes a controller that is operatively connected to the switch, the controller being configured to operate the switch from the first state to the second state automatically after a predetermined period of time has elapsed following operation of the switch to the first state.

3. The cooker according to claim 2, wherein the predetermined period of time is in the range of about 2 minutes to about 20 minutes, and is preferably in the range of about 5 minutes to about 15 minutes.

4. The cooker according to claim 3, wherein the predetermined period of time is in the range of about 5 minutes to about 10 minutes, and is preferably about 7 minutes.

5. The cooker according to claim 1, wherein the ignition system includes a user interface for operating the switch, the user interface comprising a screen, such as a touch-screen, for displaying any one or more of: a current state of the switch, a grill temperature, and time remaining until the predetermined period of time has elapsed.

6. The cooker according to claim 1, wherein the fuel support structure is configured as a receptacle, such as a basin or a tray, for holding the solid fuel, wherein the chamber has an upper opening or is upwardly open for introducing the solid fuel onto the fuel support structure from above, wherein the at least one electric heating element is located in or adjacent the chamber.

7. The cooker according to claim 1, wherein the at least one electric heating element is arranged in the chamber of the body of the cooker such that, when the solid fuel is placed on the fuel support structure, the at least one electric heating element is substantially surrounded by, and optionally in direct contact with, the solid fuel.

8. The cooker according to claim 1, wherein the fuel support structure is configured to be arranged in the chamber above the at least one electric heating element, the fuel support structure including a thermally conductive portion, optionally in the form of an insert, such as a plate member, having a lower surface arranged for thermal contact with the at least one heating element and an upper surface for thermal contact with the solid fuel.

9. The cooker according to claim 8, wherein the thermally conductive portion includes a plurality of apertures there-through between the lower surface and the upper surface.

10. The cooker according to claim 8, wherein the thermally conductive portion is formed from a metal or metal alloy, such as stainless steel.

11. The cooker according to claim 1, wherein the at least one electric heating element comprises: electrical connectors configured for electrical connection to an electrical power source via the switch; an electrical resistance heating wire that electrically interconnects the electrical connectors; and a sheath of electrically insulating and thermally conductive material surrounding and encapsulating the resistance heating wire.

12. The cooker according to claim 11, wherein the electrical resistance heating wire is formed from a nickel chromium alloy and the sheath is formed from magnesium oxide.

13. The cooker according to claim 11, wherein the at least one electric heating element includes a cover layer covering the sheath, the cover layer preferably being formed from aluminium oxide.

14. The cooker according to claim 1, wherein the at least one electric heating element is elongate and extends in a convoluted configuration to concentrate heat transfer to the solid fuel on the fuel support structure.

15. The cooker according to claim 1, further comprising a cooking grill which is mountable to the body such that the cooking grill is located spaced above the solid fuel supported on the fuel support structure in the chamber.

16. The cooker according to claim 1, wherein the ignition system includes an electric cable for connection to an electrical power supply socket to supply electrical energy to the at least one electric heating element, wherein the electric cable is wound on a spool in the body of the cooker, and wherein the spool is biased for retracting the cable.

17. A cooker, such as a barbecue, comprising:
a body defining a chamber for combustion of solid fuel, like charcoal or briquettes;
a fuel support structure for supporting solid fuel in the chamber; and
an ignition system for igniting solid fuel supported by the fuel support structure, the ignition system comprising at least one electric heating element mounted to the body for heating solid fuel supported by the fuel support structure, the at least one electric heating element configured to be switched between an electrically energized or “on” state and an electrically de-energized or “off” state;
wherein the at least one electric heating element is arranged to transfer heat to solid fuel supported by the fuel support structure to ignite the solid fuel when it is switched to the energized or “on” state.

18. The cooker according to claim 17, wherein the ignition system includes a controller that is configured to switch the at least one electric heating element from the “on” state to the “off” state automatically after a predetermined period of time in the range of 2 minutes to 20 minutes has elapsed.

19. The cooker according to claim 17, wherein the fuel support structure is configured as a receptacle, such as a basin or a tray, for holding the solid fuel and the chamber is upwardly open for introducing the solid fuel onto the fuel support structure from above, wherein the at least one electric heating element is located in or adjacent the chamber and the fuel support structure is arranged in the chamber above the at least one electric heating element; and wherein the fuel support structure includes a removable insert, such as a plate member, that covers the at least one electric heating element.

20. The cooker according to claim 19, wherein the insert has a lower surface arranged immediately above the at least one electric heating element and an upper surface for thermal contact with the solid fuel, wherein the insert includes a plurality of apertures there-through between the lower surface and the upper surface.
